(19) United States
(12) Patent Application Publication
(10) Pub. No.: US 2013/0126043 A1
(43) Pub. Date: May 23, 2013

(54) FILLING ELEMENT, AND FILLING SYSTEM OR FILLING MACHINE

(71) Applicant: Ludwig Clusserath, Bad Kreuznach (DE)

(72) Inventor: Ludwig Clusserath, Bad Kreuznach (DE)

(73) Assignee: KHS GmbH, Dortmund (DE)

(21) Appl. No.: 13/812,275

(22) PCT Filed: May 17, 2011
(86) PCT No.: PCT/EP11/02430

§ 371 Date: Jan. 25, 2013

(30) Foreign Application Priority Data
Aug. 3, 2010 (DE) 10 2010 033 168.6

(51) Int. Cl. B65B 1/04

(52) U.S. Cl. CPC B67D 3/0058
USPC 141/286; 141/57

(57) ABSTRACT

A filling element for filling containers with a lumpy liquid filler includes a liquid valve that is arranged in a liquid channel in an interior of a filling element housing and that is formed by a first valve surface, cooperating with a first valve seat, on a valve body that is movable along a filling-element axis to open and close the liquid valve, and that comprises at least two dispensing openings on filler flow channels, the dispensing openings forming a filler outlet. The filler flow channels are in flow communication with the liquid channel and with each other when the liquid valve is open and are separated from each other and from the liquid channel when the liquid valve is closed. The element also includes a separate valve arrangement that separates the filler flow channels from each other in flow terms when the liquid valve is closed.

The invention relates to a filling element for filling containers, in particular for the free-jet filling of containers with a liquid filler, for example with a lumpy filler, according to the preamble of claim 1, and to a filling system according to the preamble of claim 9.

In the context of the invention, a “lumpy filler” is to be understood to mean a filler or product which contains in a liquid component also hard or harder constituents, for example including fruit fibres and/or fruit pieces (pulp) in a fruit juice as the liquid component.

In the context of the invention, “containers” are in particular cans and bottles made from metal, glass and/or plastic, but also other packaging means which are suitable for filling with liquid or viscous products, in particular also for a free-jet filling of containers with such products.

In the context of the invention, the expression “substantially” means deviations of +/−10%, preferably +/−5%, from the exact value in each case, and/or deviations in the form of changes which have no effect on the function.

In the context of the invention, free-jet filling is to be understood to mean a method in which the liquid filler flows towards the container to be filled in a free filling jet, wherein the container does not bear with its container mouth or opening against the filling element but rather is spaced apart from the filling element or from a filler outlet thereon.

Filling elements for the free-jet filling of containers are known in various designs. In order to achieve an optimally shaped free filling jet during the filling process and to avoid any dripping of the filling element after the filling process, it is also known to provide such filling elements with a gas lock in the region of their filler outlet. Said gas lock consists essentially of a plurality of bores or filler flow channels which are formed in the filling element or in an insert, in each case extend parallel to a vertical or substantially vertical filling element axis and are open at both ends. The lower open ends of these filler flow channels form dispensing openings, from which the filler flows in the free filling jet towards the respective container during the filling process. The upper open ends or inlets of the filler flow channels cooperate with a flat, plunger-like valve body of a liquid valve, which (valve body), in order to close the liquid valve and thus end the filling process, is placed from above over all of the inlets and closes the latter, so that filler remaining in the filler flow channels after the closing operation is retained therein by virtue of a “pipette effect” and thus any dripping of the filling element due to emptying of the gas lock is prevented. One disadvantage here, however, is that such filling elements with gas locks are not suitable or are suitable only to a very limited extent for a lumpy filler which contains hard or harder constituents, since hard or harder constituents accumulate between the inlets of the filler flow channels in the inflow region of the respective gas lock and form bridges so that actual networks of hard filler constituents or fibres form over the inlets or in the inlets as the production or filling operation continues and ultimately block said inlets. Here, account should be taken of the fact that for example in fruit juices the fibrous constituents may have lengths of up to 20 mm, so that these constituents or fibres may on their own clog bores or filler flow channels having a diameter of 10 mm.

In order to avoid this problem, for the free-jet filling of containers with a lumpy filler, use is presently made of filling elements which have for forming the free filling jet, downstream of the respective liquid valve in the direction of flow of the filler, just one single filler flow channel of relatively large cross-section, for example having a diameter of at most 7 mm-9 mm, wherein the liquid valve which controls the flow of filler and/or the quantity of filler to be introduced into the respective container, and which consists essentially of a valve body having a valve surface and of a valve seat cooperating with the valve surface, is provided upstream of an inlet of the single filler flow channel of relatively large diameter, as seen in the direction of flow of the filler.

One disadvantage here inter alia is the fact that only relatively low filling rates (quantity of filler introduced per unit time) and thus also only relatively low outputs (number of filled containers per unit time) can be achieved for a filling system comprising such filling elements and/or for a corresponding filling machine. With such filling elements, it is moreover not possible to improve the filling output by arranging a plurality of parallel filler flow channels of large diameter, since then, when the liquid valve is closed, an emptying of the filler flow channels and thus an undesirable dripping of the respective filling element cannot be prevented. This can be attributed to the fact that the filler flow channels, once the liquid valve has been closed, are connected to each other in the region of their inlets and thus mutually vent each other, with the result that filler still present in these channels after the liquid valve has closed is fully discharged. This is because the interconnected filler flow channels form a communicating pipe system, so that even extremely small differences in the quantities of filler remaining in the individual filler flow channels lead to a movement of the filler within this system and thus to the gas lock function being lost, which results in an emptying of the filler flow channels.

The object of the invention is to provide a filling element which avoids the aforementioned disadvantages and also allows the container to be filled with lumpy filler while ensuring a high filling output and optimal shaping of the free filling jet. In order to achieve this object, a filling element is configured according to claim 1. A filling system forms the subject matter of claim 9.

One special feature of the invention lies in the fact that, in addition to the actual liquid valve, which is once again formed essentially by a first valve surface formed on a valve body and by a corresponding first valve seat, a further valve arrangement is provided which, after the liquid valve has been closed, separates the inlets of the individual filler flow channels used for shaping the free filling jets and closes said inlets, so that the filler flow channels do not form a communicating pipe system when the liquid valve is closed. Even with a relatively large diameter of the filler flow channels (e.g. 7 mm-9 mm), the pipette function is fully maintained and the quantity of filler remaining in the respective filler flow channel once the liquid valve is closed is reliably retained in said channel, thereby effectively preventing any emptying of the filler flow channels and/or any dripping of the filling element once the liquid valve is closed.

In this case, the further valve arrangement is formed for example by a second valve surface which is offset spatially from the first valve surface, preferably is offset axially therefrom relative to a filling element axis, and which cooperates with a second valve seat which is likewise offset spatially from the first valve seat, preferably is offset axially therefrom relative to the filling element axis, namely in each case preferably in such a way that the second valve surface is located downstream of the first valve surface and the second valve seat is located downstream of the first valve seat, as seen in the direction of flow of the liquid filler.

In one preferred embodiment of the invention, the second valve surface is provided on a valve body portion or else on an element connected to the valve body, and specifically for example as an outer or circumferential surface of the valve body portion or of the aforementioned element. The valve seat is for example at least one surface which does not move with the valve body and against which the second valve surface bears sealingly at least when the liquid valve is closed, said sealing effect being at least sufficient to close and to mutually block the filler flow channels and/or the inlets thereof to prevent a communicating pipe system and/or the effect thereof.

In one preferred embodiment of the invention, the filler flow channels are formed in the valve body which also has the first valve surface, wherein then, in the closed state of the liquid valve, the inlets of the filler flow channels are closed by the valve body portion which bears against an inner surface of the filling element or filling element housing that forms the second valve seat.

Further developments, advantages and possible uses of the invention will also become apparent from the following description of examples of embodiments and from the figures. All the features described and/or shown form in principle, per se or in any combination, the subject matter of the invention, regardless of the way in which they are combined in the claims or the way in which they refer back to one another. The content of the claims is also included as part of the description.

The invention will be explained in more detail below with reference to the figures and on the basis of an example of embodiment. In the figures:

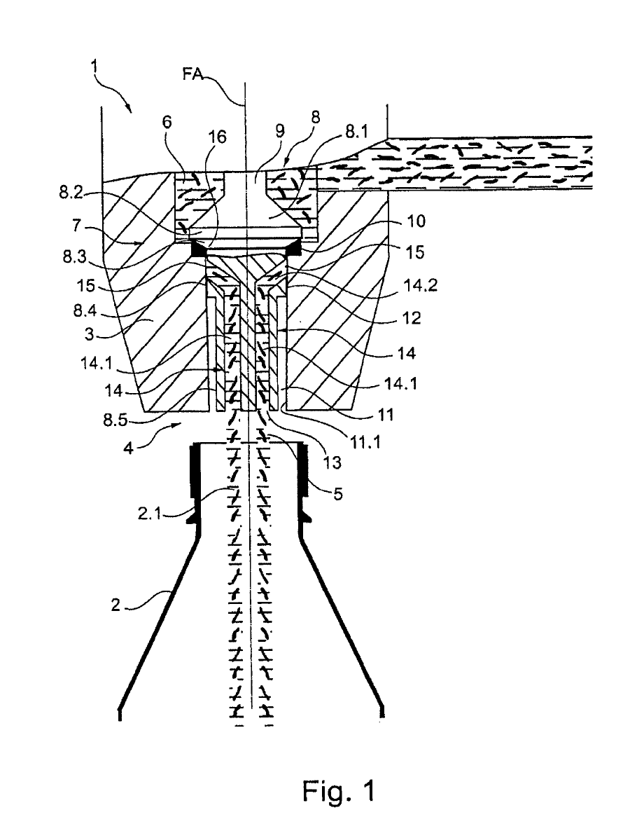

FIG. 1 shows in a simplified partial view a filling element of a filling machine or filling system for the free-jet filling of containers with a lumpy filler, together with a partial view of a container in the form of a bottle arranged below the filling element;

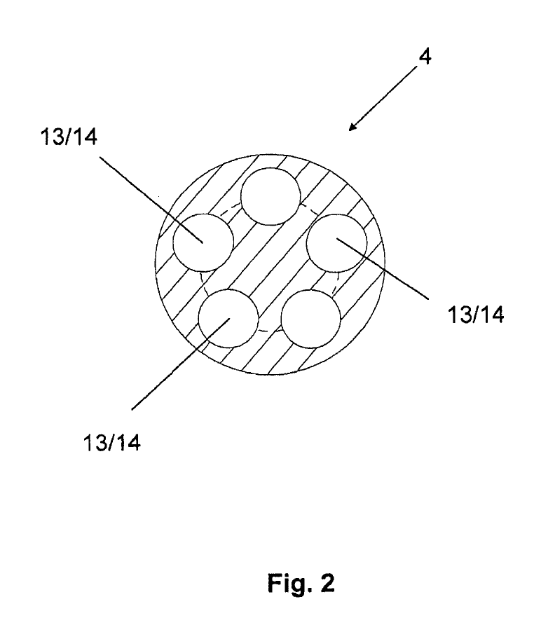

FIG. 2 shows a plan view of the underside of the filling element of FIG. 1 in the region of a filler outlet.

In the figures, 1 denotes a filling element for the free-jet filling of containers in the form of bottles 2 which, during the filling process, held by a container or bottle carrier (not shown), are arranged with their container or bottle opening 2.1 at a distance below the filling element 1 or below a filler outlet 4 formed on the underside of the filling element 1 or filling element housing 3, so that the liquid filler during the filling process flows as a free filling jet 5 through the bottle opening 2.1 into the respective bottle 2.

Formed in the filling element housing 3 is a filler channel or liquid channel 6, to which there is fed, for example in an upper region, the filler or the components forming the filler. Provided in the liquid channel 6 is a liquid valve 7 which can be opened and closed for the controlled dispensing of the filler into the respective bottle 2. One important component of the liquid valve 7 is a valve body which is provided or formed at the lower end of a valve plunger 9 oriented with its longitudinal axis in a vertical filling element axis FA, and which in order to open and close the liquid valve 7 can be moved up and down by a predefined stroke (double-headed arrow A in FIG. 1) in the filling element axis FA by means of an actuating mechanism (not shown).

In the illustrated embodiment, the valve body 8, starting from the lower end of the valve plunger 9, is formed with a valve body portion 8.1 which firstly widens in the shape of a truncated cone, then with a substantially circular-cylindrical valve body portion 8.2, then with a valve body portion 8.3 which narrows in the shape of a truncated cone, then with a substantially circular-cylindrical valve body portion 8.4 and then with a valve body portion 8.5 which is a likewise circular-cylindrical but the external diameter of which is smaller than the external diameter of the valve body portion 8.4.

FIG. 1 shows the liquid valve 7 in its closed state, in which the cone surface of the valve body portion 8.3 forming a first valve surface bears sealingly against a first valve seat 10 provided on the inner surface of the liquid channel 6 and formed in the illustrated embodiment by a ring seal or seat seal, so that there is no flow connection between the liquid channel 6 and the filler outlet 4.

Provided in the filling element housing 3, on the underside thereof, is an opening 11 which is coaxial with the filling element axis FA and which opens into the liquid channel 6 in the region of the valve seat 10 and the internal cross-section of which is adapted to the external cross-section of the valve body portion 8.4 in such a way that, at least in the closed state of the liquid valve 7, the outer surface of the valve body portion 8.4 bears as sealingly as possible against the inner surface 11.1 of the opening 11. In the illustrated embodiment, the design is such that, when the liquid valve 7 is closed, the valve body portions 8.4 and 8.5 are fully accommodated in the opening 11 and, when the liquid valve 7 is open, i.e. when the valve body 8 is moved upwards by the stroke A in the filling element axis FA out of the position shown in FIG. 1, the valve body portion 8.4 is located with an upper axial partial length above the valve seat 10 but with a lower axial partial length still within the opening 11. As the liquid valve 7 is opened and closed, therefore, the valve body portion 8.4 is moved in a piston-like manner with its axial upper partial length out of the opening 11 and into the liquid channel 6 and is moved with its upper axial partial length back into the opening 11 as the liquid valve 7 is closed.

Provided on the outer surface of the valve body portion 8.4 directly at the transition between the valve body portions 8.4 and 8.5 in the illustrated embodiment is a seat seal or ring seal 12 which concentrically surrounds the filling element axis FA and which bears against the inner surface 11.1 and thus seals off the gap between this inner surface 11.1 and the outer surface of the valve body portion 8.4.

In the illustrated embodiment, the filler outlet 4 is formed by the dispensing openings 13 of a plurality of filler flow channels 14 which are provided in the valve element portions 8.4 and 8.5.

The dispensing openings 13 are located on the lower end of the valve body 8 or valve body portion 8.5, said lower end in the illustrated embodiment being flat or substantially flat and being oriented in a plane perpendicular to the filling element axis FA.

The filler flow channels 14 are in each case distributed at uniform angular spacings around the filling element axis FA, at a radial distance therefrom, and extend parallel to the filling element axis FA along a larger partial length 14.1 starting from their respective dispensing opening 13 and at an angle to the filling element axis FA along a subsequent partial length 14.2, so that the longitudinal extension of the respective partial length 14.2 encloses with the filling element axis FA an acute angle, i.e. an angle smaller than 90°, which opens in the upward direction, i.e. towards the side facing away from the lower end of the valve body 8.

The partial lengths 14.2 end in each case at the circumferential or outer surface of the valve body portion 8.4 in openings or inlets 15 which are distributed at uniform angular spacings around the filling element axis FA, namely in the illustrated embodiment with the centre points of their openings on a common circular line which concentrically surrounds the filling element axis FA. The inlets 15 are still located above the ring seal 12 and, with the liquid valve 7 closed, below the valve seat 10. In addition, the filler flow channels 14 are configured in such a way that the longitudinal extensions of the partial lengths 14.1 and 14.2 of each filler flow channel 14 lie in a common plane radial to the filling element axis FA.

With the liquid valve 7 closed, the inlets 15 are closed by the inner surface of the opening 11 below the valve seat 10. With the liquid valve 7 open, the openings 15 are located on the partial length of the valve body portion 8.4 raised above the valve seat 10, so that the filler flow channels 14 are connected to the liquid channel 6 via their inlets 15 and thus, with the liquid valve 7 open, the filler can flow from the liquid channel 6 into the filler flow channels 14 and out from the latter through the filler outlet 4 or the dispensing openings 13 therein into the respective bottle 2 as a free filling jet 5.

Due to the plurality of filler flow channels 14, given an optimal configuration of the free filling jet 5, optimal conditions are achieved when filling the respective bottle 2, in particular including with regard to the filling output.

As the liquid valve 7 is closed, not only is the flow connection between the liquid channel 6 and the filler outlet 4 interrupted by the valve body portion 8.3 bearing against the valve seat 10, but the filler flow channels 14 are also closed at their upper end, i.e. at the inlets 15, namely due to the fact that the valve body portion 8.4 bears sealingly with its outer surface, which forms a second valve surface, against the inner surface 11.1 which thus forms a second valve seat that closes the filler flow channels 14 individually, i.e. at their inlets 15.

Once the liquid valve is closed, the filler still located in the filler flow channels 14 is effectively retained in these channels (pipette effect). A mutual venting of the filler flow channels 14 is not possible via the closed inlets 15. A communicating pipe system is prevented. This applies even when the filler channels 14 have a relatively large diameter, for example a diameter in the range between 7 mm and 9 mm, so as to achieve inter alia when the liquid valve 7 is open, due to all the filler flow channels 14, a flow cross-section that is as large as possible for the filler flowing into the respective bottle 2 and thus high filling rates and high outputs for the filling system or filling machine (number of filled bottles 2 per unit time) and in particular also to avoid any clogging or blocking of the filler pathways within the filling element by hard or harder filler constituents, for example by fruit fibres and/or fruit pieces.

As the liquid valve 7 is closed, i.e. as the valve body portion 8.4 is moved back into the opening 11, harder filler constituents which may have accumulated in the region of the inlets 15 shear off at the upper edge region 16 of this opening.

The significant advantages of the filling element 1 therefore lie inter alia
in that with the filling element 1, due to the plurality of filler flow channels 14, a free-jet filling with an optimal filling jet formation is possible with a high filling rate and/or with a high filling output (number of filled bottles per unit time), in particular including a trouble-free filling of the bottles 2 or other containers with a lumpy filler, and
in that, once the liquid valve 7 has been closed, despite a relatively large cross-section of the filler flow channels 14, any emptying of these channels and thus dripping of the filling element 1 is reliably avoided.

In one preferred embodiment of the invention, the actuating mechanism which actuates the valve body 8 via the valve plunger 7 is configured in such a way that, for CIP cleaning and/or disinfection for example, the valve body 8 can be moved so far upwards beyond the normal stroke A that the valve body portion 8.4 is located completely outside the opening 11 and the lower end of the opening 11, which is then closed for example by a closure cap or another closure element, is connected to the liquid channel 6 of enlarged total flow cross-section not only via the filler channels 14 but also via an annular channel that surrounds the valve body portion 8.5, namely for a particularly intensive treatment of all the surfaces also of the valve body 8 during the CIP cleaning and/or disinfection.

The invention has been described above on the basis of examples of embodiments. It will be understood that numerous changes and modifications are possible without thereby departing from the concept on which the invention is based.

For instance, it is possible inter alia that the number and/or arrangement of the filler channels 14 differs from the number and/or arrangement shown in FIGS. 1 and 2. Furthermore, it is in principle also possible to omit the ring seal 12. To this end, it is particularly advantageous to select the dimensions and tolerances of the cooperating components, namely of the inner wall of the opening 11 and the outer wall of the valve body portion 8.4, in such a way that the upper inlets 15 of the filler flow channels 14 are hydraulically and pneumatically completely separated from each other when the filling valve is closed.

### LIST OF REFERENCES

1 filling element
2 bottle
2.1 bottle opening
3 filling element housing
4 filler outlet
5 free filling jet
6 liquid channel in the filling element housing 3
7 liquid valve
8 valve body
8.1-8.5 valve body portion
9 valve plunger
10 valve seat or seat seal
11 opening
11.1 inner surface of the opening 11
12 ring seal
13 dispensing opening
14 filler flow channel in the valve body 8
15 upper inlet of the filler flow channel 14
16 edge region or transition region
A stroke movement of the valve body 8
FA filling element axis

1-10. (canceled)

11. An apparatus comprising a filling element for filling containers with a lumpy liquid filler, said filling element comprising a liquid valve that is arranged in a liquid channel in an interior of a filling element housing and that is formed by a first valve surface, cooperating with a first valve seat, on a valve body that is movable along a filling-element axis to open and close said liquid valve, and that comprises at least two dispensing openings on filler flow channels, said dispensing openings forming a filler outlet, wherein said filler flow channels are in flow communication with said liquid channel and with each other when said liquid valve is open and are separated from each other and from said liquid channel when said liquid valve is closed, and a separate valve arrangement that separates said filler flow channels from each other in flow terms when said liquid valve is closed.

12. The apparatus of claim 11, wherein said separate valve arrangement is formed by a second valve surface that is spatially offset from said first valve surface axially therefrom relative to said filling-element axis, and by a valve seat cooperating therewith that is spatially offset from said first valve seat axially from said first valve seat relative to said filling-element axis.

13. The apparatus of claim 12, wherein said filler flow channels each have at least one inlet, via which said filler flow channels are connected to said liquid channel when said liquid valve is open, and which, when said liquid valve is closed, are closed by one of said second valve surface and a second valve seat.

14. The apparatus of claim 13, wherein said inlets of said filler flow channels are arranged upstream of said first valve seat in a direction of flow of said filler when said liquid valve is open.

15. The apparatus of claim 13, wherein said filler flow channels are formed in one of said valve body and an element connected to said valve body in such a way that said inlets of said filler flow channels are provided on one of an outer surface and a circumferential surface of one of said valve body and an element connected to said valve body, downstream of said first valve surface in a direction of flow of said filler.

16. The apparatus of claim 15, wherein said filling element housing comprises one of a recess and an opening for accommodating a valve body portion of said one of said valve body and an element connected to said valve body that includes said inlets of said filler flow channels when said liquid valve is open such that at least one edge region surrounding a respective inlet of said one of an outer surface and a circumferential surface of one of said valve body and an element connected to said valve body bears against and seals an inner surface of said one of a recess and opening, said inner surface forming the second valve seat.

17. The apparatus of claim 16, wherein said valve-body portion is configured to be guided in a piston-like manner in said one of a recess and an opening.

18. The apparatus of claim 17, wherein said valve-body portion comprises one of a circumferential surface and an outer surface formed in a cylinder having a circular cross-section, and wherein said one of a recess and an opening is adapted to an external cross-section of said valve body portion at least over a partial length that, when said liquid valve is closed, accommodates said valve-body portion.

19. The apparatus of claim 11, wherein said filler flow channels, starting from said dispensing openings thereof, each have a longer partial length extending in a direction of said filling-element axis and a partial length having said inlet, and wherein longitudinal extensions of said partial lengths having said inlets preferably each enclose, with said filling-element axis, an angle of less than 90° that opens towards a side facing away from said dispensing opening.
